(19) United States
(12) Patent Application Publication
(10) Pub. No.: US 2015/0178759 A1
(43) Pub. Date: Jun. 25, 2015

(54) LOYALTY PROGRAM BASED ON TIME SAVINGS

(71) Applicant: EBAY INC., SAN JOSE, CA (US)

(72) Inventor: Dane Glasgow, Los Altos, CA (US)

(73) Assignee: EBAY INC., SAN JOSE, CA (US)

(21) Appl. No.: 14/135,419

(22) Filed: Dec. 19, 2013

(51) Int. Cl. G06Q 30/02

(52) U.S. Cl. CPC G06Q 30/0226; G06Q 30/0215; G06Q 30/0235

(57) ABSTRACT

Users of a web site may save time by completing purchases via an electronic network. A transaction completed at least partially online, for example, may require less user time than an alternative transaction that is completed by traveling to a physical store location. A computer system may estimate an amount of time saved by a user for a transaction, relative to an alternative transaction, using various techniques such as estimating an amount of travel time that may be saved. User loyalty accounts may be credited with the estimated amounts of time saved for transactions. Estimated amounts of time saved may be displayed to users, which may encourage additional purchases to be made via a web site or service that supports estimation of time savings for transactions.

### TECHNICAL FIELD

The subject matter disclosed herein generally relates to data processing, and relates more particularly to estimating user time savings for transactions completed at least in part via an electronic network, and the adjustment of an account balance based on such time savings.

### BACKGROUND

Consumer transactions may be a time-consuming endeavor. A consumer who travels to a grocery store, fills a shopping cart, waits to check out of the store, and then travels back home may spend an hour or more in total. The time spent by a user in such a transaction may be even greater during peak shopping times when check out lines may be longer, or during rush hour when traffic is congested.

Consumers who make purchases (e.g., with a credit card) may also receive cash back benefits, such as 1% of all spending using the card. A monthly credit card statement may indicate that a consumer spent $5,000 in one month, for example, and earned $50 in cash back rewards.

This type of benefit may have drawbacks, however. Although a consumer may see that she saved $50 in cash back rewards in a one month period, this may also serve as a (possibly unpleasant) reminder of the consumer's level of spending. Further, the consumer may also wish to keep such information private. A friend or family member who sees that a consumer earned $50 in cash back rewards in a month, for example, may be able to infer the consumer's level of spending (which the consumer may not wish to reveal).

Accordingly, in some cases, consumer transactions may be time consuming, and may have benefits that are perceived negatively.

### BRIEF DESCRIPTION OF THE DRAWINGS

Some example embodiments are briefly described below, and are illustrated by way of example in the accompanying drawings. The scope of this disclosure, including the appended claims, is not limited to these examples.

FIG. 1 is a block diagram depicting a system that includes a server system and a client device, according to an example embodiment.

FIG. 2 is a diagram that illustrates a conceptual example of flow charts for user time spent in two different shopping procedures, according to an example embodiment.

FIG. 3 is a flow chart of one example embodiment of a method relating to estimating an amount of time saved by a user in at least a portion of a first transaction relative to an alternative transaction.

FIG. 4 is a diagram of an example embodiment of a user web page with loyalty-related information for time savings.

FIG. 5 is a block diagram of an example embodiment of a computer-readable medium.

FIG. 6 is a block diagram of an example embodiment of a machine (e.g., computer system).

### DETAILED DESCRIPTION

Users who complete at least a portion of a transaction via an electronic network may spend less time than they would by otherwise engaging in an alternative transaction. For example, a user who makes an online purchase via a web site such as EBAY.COM, or using a service such as EBAY NOW, may spend less time than if that user traveled to a nearby store and purchased the same goods or services.

Thus, a server system may calculate an estimated amount of time saved by a user who completes at least a portion of a transaction via an electronic network. Calculating an estimated amount of time saved for a transaction may include estimating an amount of time saved traveling, an amount or time saved shopping, or an amount of time saved checking out. Calculating an estimated amount of time saved for a transaction may include using multiple data sources in some instances, including determining a merchant and physical store location for an alternative transaction to a first transaction in which a user participates.

A consumer loyalty account may also be adjusted based on an estimated amount of time saved for one or more transactions. For example, a user's account on a web site such as EBAY.com may reflect a total amount of time saved for a number of different transactions on that web site. The account may be credited with an estimated time savings, and the total time savings may be displayed to a user. Thus, the user may receive a positive reminder showing her how much time she has saved by ordering online, for example. Because the user may more fully appreciate how much time she is saving by using the web site for transactions, the user may be encouraged to use the web site to a greater degree in the future, in some cases.

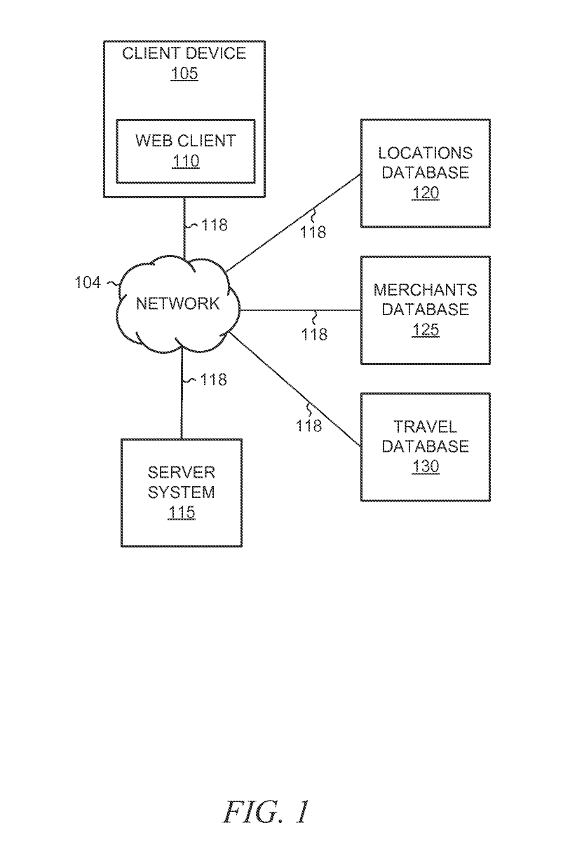

Turning to FIG. 1, a block diagram is shown depicting a system that includes a client device 105, server system 115, a locations database 120, a merchants database 125, and a travel database 130. As shown, server system 115 is linked to client device 105, locations database 120, merchants database 125, and travel database 130 via network connections 118 and an electronic network 104. Additional devices, servers, networks, network connections, databases, or other data or communication-related structures may be present in various other embodiments in the system of FIG. 1, as would occur to one with skill in the art.

In the embodiment of FIG. 1, client device 105 includes a web client 110. Web client 110 may be browsing software such Mozilla® Firefox™, Google® Chrome™, Microsoft® Internet Explorer™, or another program configured to allow transactions to, in various embodiments.

Client device 105 may be any of a variety of different device types. For example, client device 105 may be a laptop or desktop computer system, or may be a mobile device such as a smartphone (e.g., iPhone™ device, Android™ device) Consistent with sonic embodiments, client device 106 may alternatively be a tablet computer, such as an iPad™, a set-top box (STB) such as provided by cable or satellite content providers, a video game system console such as the Nintendo® Wii™, the Microsoft® Xbox 360™, or the Sony® PlayStation™ 3, or other any number of other suitable computing devices.

Consistent with some example embodiments, client device 105 may include any appropriate combination of hardware or software, and have one or more processors capable of reading and executing instructions stored on a non-transitory machine-readable medium. Client device 105 may interface via one or more connections 118 with a communication network 104 (e.g., the Internet, a Wide Area Network (WAN), Local Area Network (LAN)). Depending on the form of client device 105, any of a variety of types of connections 118 and communication networks 104 may be used. Communication network 104 may therefore include a cellular network or other wireless network in various example embodiments.

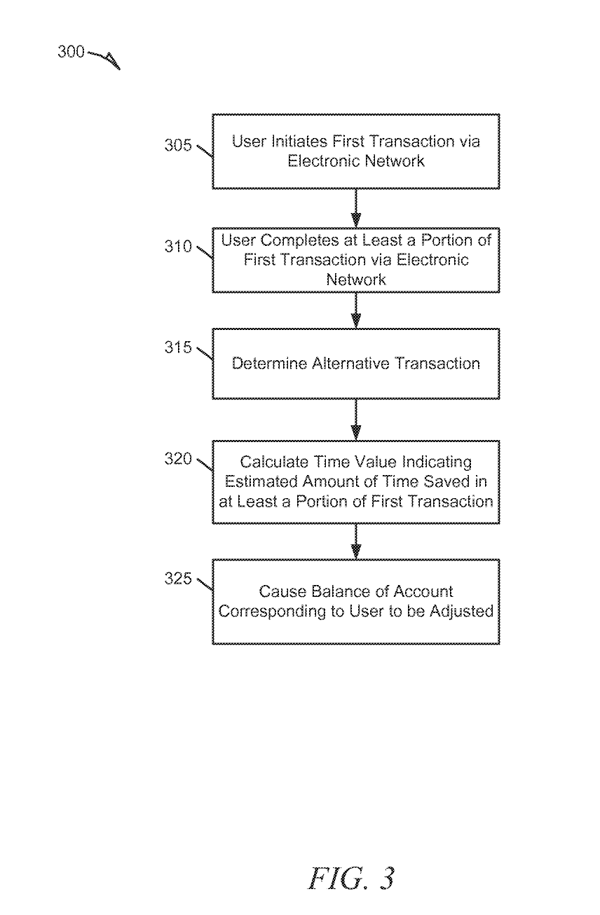

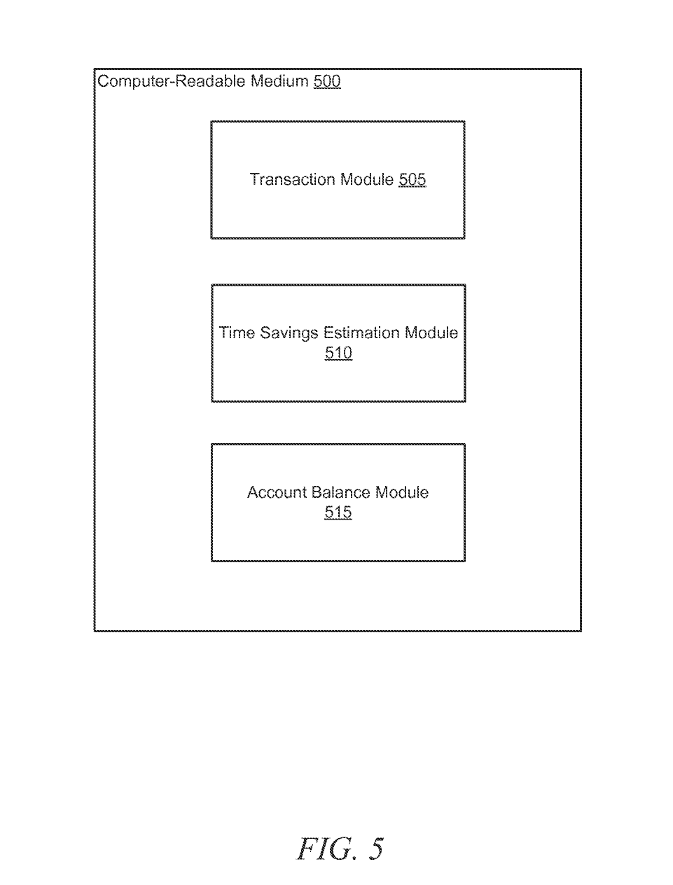

In the example embodiment shown, server system 115 is configured as a web server. Server system 115 may therefore allow users to browse web pages and view goods or services available for purchase. Server system 115 is configured to facilitate the processing of transactions made via network 104 in the example embodiment shown, and may therefore interact with one or more payment systems (e.g., credit card processors, PAYPAL systems, etc.). In various example embodiments, server system 115 may include one or more different computer systems linked via a network, as will be appreciated by one of skill in the art. Server system 115 may also be configured to execute one or more operations described relative to the method of FIG. 3, and include executable software or hardware modules as further described below relative to FIG. 5.

In the example embodiment of FIG. 1, server system 115 is configured to communicate with locations database 120, merchants database 125, and travel database 130 via network 104. In the example embodiment shown, databases 120, 125, and 130 are included as part of one or more other networked computing systems. Locations database 120, for example, may be a database used in conjunction with a location service such as GOOGLE maps (e.g., a service configured to provide one or more routes between two physical locations). In other example embodiments, however, all or a portion of locations database 120, merchants database 125, and travel database 130 are included within server system 115. In other words, in different example embodiments, locations database 120, merchants database 125, and travel database 130 may be distributed over one or more computing systems that may or may not include server system 115.

Locations database 120 is configured to store information regarding various physical locations in the example embodiment shown. For example, locations database 120 may include a list of addresses corresponding to various merchant locations or other locations at which an alternate transaction may occur, such as fulfillment centers that may store merchandise from a plurality of merchants, or pick-up kiosks that have storage lockers. Locations database 120 may also include one or more addresses corresponding to locations associated with a user (home, work, school, etc.) in various example embodiments.

In the example embodiment shown, merchants database 125 is configured to store information regarding various stores, service establishments (such as coffee shops, bars, and restaurants), and other establishments at which transactions may be conducted (including fulfillment centers or pick-up kiosks, in some example embodiments). In some instances, merchants database 125 includes information regarding goods or services that may be available through an establishment. For example, merchants database 125 may include information regarding inventory at a store such as BEST BUY or TARGET. In other cases, merchants database may include information regarding food or beverages that may be purchased at a service establishment. Merchants database 125 is not limited to information such as in the examples above, however. In some example embodiments, all or a portion of merchants database 125 may be suitably combined with locations database 120.

Travel database 130 is configured to store information regarding travel times between physical locations in the example embodiment shown. Accordingly, travel database 130 is usable to estimate a travel time between a first physical location (e.g., a user's home) and a second physical location (e.g., a store). In one example embodiment, a computer system including travel database 130 may estimate a travel time between two locations, while in another example embodiment, server system 115 may perform such a calculation based on information acquired from travel database 130. Travel time estimation may be based on current or projected traffic conditions (e.g., at a time an order is placed or delivered), mode of transport (e.g., automobile, bus, subway, on foot, etc.), or current or projected weather conditions, in various example embodiments. Travel time estimation may also include estimations based on one or more other conditions, such as traffic accidents or street closures.

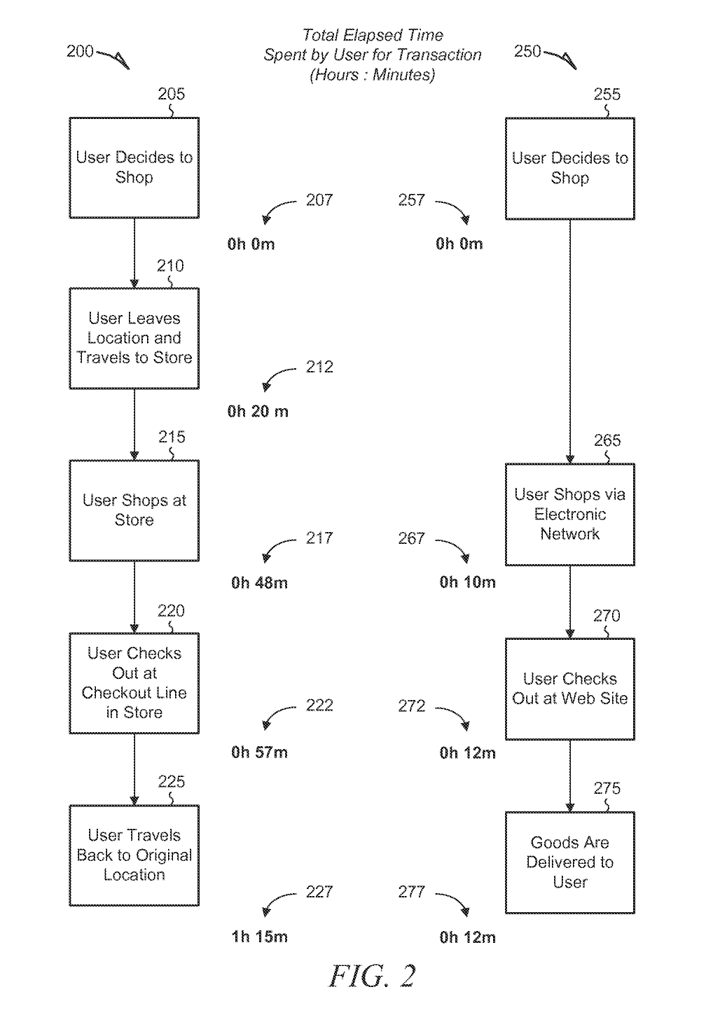

Turning to FIG. 2, a diagram that illustrates a conceptual example of flow charts reflecting user time spent in two different shopping procedures. In method 200, a user shops for products by traveling to store, while in method 250, a user shops via an electronic network (e.g., the Internet). In these conceptual examples, the total time spent by a user to complete one transaction by traveling to a store is one hour and fifteen minutes, while the total time spent by the user to complete a similar transaction via an electronic network is only twelve minutes. Accordingly, in these examples, a user might save over an hour of time by transacting online instead of by traveling a store.

In one example embodiment, method 200 may correspond to a user traveling to a TARGET store to purchase groceries and household supplies, for example, while method 250 may correspond to the same user ordering the same groceries and household supplies from a TARGET store via a service that delivers to a user's location, such as EBAY NOW.

In the example embodiment shown, operations 205, 210, 215, 220, and 225 correspond to actions taken by a user to complete a transaction at a physical store location. Time indications 207, 212, 217, 222, and 227 respectively correspond to the total cumulative amount of time spent by a user after corresponding operations of method 200. Likewise, in the example embodiment shown, operations 255, 265, 270, and 275 respectively correspond to actions taken by a user to complete a transaction via an electronic network. Time indications 257, 267, 272, and 277 likewise correspond to the total cumulative amount of time spent by a user after corresponding operations of method 250, as shown in the example embodiment of FIG. 2.

As will be appreciated, completing a transaction (or a portion thereof) via an electronic network may represent a time savings for a user. In the example embodiment of FIG. 2, a user transacting online does not have to spend time traveling to or from a physical store location, and may also save time in the shopping phase (e.g., selection of goods or services) and checkout phase (e.g., paying for goods or services). In some instances, a user may choose to pickup items purchased online from a physical store location using a service such as EBAY LOCAL. In these instances, while a user may still spend time traveling to and from a location such as their home, the user may nonetheless save time by reducing shopping and checkout times, for example. Many different variations are possible in which at least a portion of a transaction is completed via an electronic network, and time savings for a user may vary according to such cases.

Turning to FIG. 3, a flow chart is shown of one example embodiment of a method relating to estimating an amount of time saved by a user in at least a portion of a first transaction relative to an alternative transaction. One or more operations of method 300 may be performed by a server system (e.g., server system 115) in various example embodiments, such as operation 115, operation 320, or operation 325. In some example embodiments, one or more operations of method 300 may be omitted, while in other example embodiments, one or more additional operations may be performed

In operation 305, a user initiates a first transaction via an electronic network such as electronic network 104. This operation may include the user opening a web browser such as web client 110, for example, and browsing a web site. In operation 310, the user completes at least a portion of the first transaction via the electronic network. This operation may include the user selecting one or more goods or services from a web site and making payment, for example. In some example embodiments, operations 305 and 310 may be performed at least in part via a user computing device such as client device 105, as well as server system 115 (e.g., client device 105 may interact with server system 115 in these operations).

Note that as used herein the term “one or more goods or services” refers to at least one good or service. Thus, this phrase may refer to one or more goods, one or more services, or one or more goods and one or more services. The phrase “plurality of goods or services,” as used herein, refers to at least two goods, at least two services, or at least one good and at least one service. Also note that generally, although the phrase “one or more” is used in this disclosure, the phrases “a” and “an” also refer to one or more instances, and do not refer to only a single instance unless specifically indicated.

In operation 315, server system 115 (or another suitable system) determines an alternative transaction to the first transaction initiated by the user in step 305. In one example embodiment, the alternative transaction is a transaction in which all aspects are conducted in person at a physical store or other location (similar to method 200). In other example embodiments, the alternate transaction may be any transaction that differs from the first transaction in terms of shopping (selection of goods or services), travel (going to a store vs. having an order delivered), order pickup (checking out conventionally at a register or picking up a pre-ordered selection of goods or services, for example), or payment (paying using a physical instrument at a store location vs. paying via an electronic network using client device 105, for example).

In the example embodiment shown in FIG. 3, the alternative transaction corresponds to a first good or service included in the first transaction. Thus, server 115 may determine a same or similar good or service as a corresponding good or service included in the first transaction. Note that the term “corresponding to a first good or service,” as used herein, thus refers to a same good or service as the first good or service (e.g., an identical item), and may also refer to a substitute or similar good or service (e.g., as determined by server system 115). Accordingly, in one example embodiment, server system 115 is configured to determine a substitute or similar good or service for a first good or service.

In order to determine an alternate transaction to a first transaction, server system 115 may determine a particular physical location of a particular merchant or other entity (e.g., operator of a fulfillment center or pick-up kiosk) that is capable of handling the alternate transaction. Accordingly, server system 115 may communicate with locations database 120 or merchants database 125 to determine such an entity and physical location.

For example, if a first transaction is an online purchase from BESTBUY.COM, in order to determine an alternate transaction, server 115 may determine a physical BEST BUY location that is near to a user's location. In some instances, server 115 may also determine a different store (e.g., TARGET) that is near to a user's location and carries a similar (or same) good or service that is included in the first transaction. For example, a first transaction may include a first universal serial bus (USB) keyboard that is available for purchase from BESTBUY.COM, while an alternate transaction may include a different USB keyboard with the same or similar functionality that is available from a TARGET store. Accordingly, in various example embodiments, determining an alternative transaction includes determining a merchant, a physical location corresponding to that merchant, or a same or similar good or service to a good or service that is included in a first transaction.

In some instances of operation 315, user input may be received and evaluated by server system 115 in order to determine an alternate transaction. For example, server system 115 may determine a plurality of alternate transactions (or portions thereof) and allow a user to select one in which they would be most likely to engage as an alternate to a first transaction. Accordingly, server system 115 may transmit information to web client 110, for example, which would cause a display of options to be presented to a user. These options may allow the user to select from one or more merchants and locations, as well as select from one or more alternate (e.g., similar) goods or services to a good or service that is included in a first transaction.

Thus, in some cases, a user may choose a particular alternate transaction to be used to determine time savings for a purchase made via a first transaction. As just one example, during operation 315, server 115 might cause a user to be presented with the option of selecting from a WAL-MART store that is 12 miles away from a user location, or a TARGET store that is 16 miles away from the user location. Even though the WAL-MART store is closer in this example embodiment, the user might choose the TARGET store as the alternate transaction for any number of reasons (such as the user generally prefers to shop at TARGET, even if it means a longer trip).

Multiple alternative transactions may also be determined for a first transaction in some example embodiments. For example, a first transaction (conducted online) may include multiple goods or services that cannot be acquired from a single nearby physical store location. In such cases, multiple alternative transactions could be determined for different nearby physical stores. The user might order two different items, for example, that are not both in stock at a particular local store. In such a case, step 315 may therefore include determining two or more alternative transactions that would be necessary to acquire all the goods or services included in the first transaction. Additional operations relative to method 300, such as estimating how much time a user is saving with a first transaction, may be adapted accordingly (for example, estimating a travel time by car from the user's home to a first store, then to a second store, then back to the user's home).

In operation 320, server system 115 (or other suitable system) calculates a time value indicating an estimated amount of time saved in at least a portion of a first transaction initiated by the user in step 305. In various instances, time may be saved by a user for different aspects of a particular transaction, such as in-store shopping time, in-store checkout time, or travel time to or from a store. (Note that although the term “store” is used in many examples herein, this term should be broadly understood as including any establishment at which goods or services are available for purchase or pickup, and therefore may include restaurants, coffee shops, kiosks, fulfillment centers, and other types of business).

One aspect of operation 320 includes estimating an amount of time saved in a shopping process (e.g., shopping online via a web browser vs. physically shopping in a store), in one example embodiment. For example, server 115 may track or receive information indicating the amount of time a user takes to place an item in an online shopping cart. Server 115 may likewise estimate a corresponding amount of time it would take a user to acquire a same or similar item by walking through a store and placing that item in a physical shopping cart.

Estimation of shopping time within a store may be performed in a variety of manners in different example embodiments. In one example embodiment, all items may be assigned a single time cost (e.g., 75 seconds). In another example embodiment, a base time cost is used (e.g., 3 minutes) and then an additional time cost per item (e.g., 45 seconds) is assigned. Thus, in such an embodiment, the shopping time in a grocery store to purchase three items (a bunch of carrots, a packet of hamburger meat, and a loaf of bread) might be estimated at 5 minutes, 15 seconds (3 minutes of base time cost, plus 45 seconds per item).

Many different variations of shopping time estimation are possible. In some instances, different estimation metrics may be used for different stores. Accordingly, a larger store might have a higher base cost of time for shopping (placing items in a cart). Thus, in another example embodiment, a store classified as “small” might have a 1 minute shopping base cost of time, while “medium” and “very large” stores might respectively have shopping base costs of time of 2 minutes and 4 minutes. Such information regarding store size may be included in merchants database 125, for example.

Another aspect of operation 320 includes estimating an amount of time saved in a checkout phase (e.g., payment phase) of shopping, in one example embodiment. The time a user spends to checkout for an online purchase may be tracked by or reported to server system 115, for example, while in-store checkout times are estimated. These times may be compared to determine a time savings for a user in a first transaction vs. an alternative transaction.

In-store checkout times may be estimated according to various schemes. In one case, in-store checkout times are estimated by adding an estimated base time (e.g., 40 seconds) to an estimated time per good or service purchased (e.g., 5 seconds per item to be scanned at a register). In this example, a trip to a grocery store to buy 10 items would therefore have an estimated checkout time of 90 seconds (40 seconds+50 seconds (10 items times 5 seconds per item). Note that in sonic instances, the estimated base time for checkout may vary by a time of day at which the first or alternate transaction occurs. Higher volume periods, such as during lunch time, after work and before dinner time, or certain weekend hours, for example, may be assigned higher checkout base times as a user may be more likely to wait in line at a register at such times.

In one example embodiment, operation 320 includes subtracting an amount of time that a user takes to complete at least a portion of a first transaction via an electronic network. For example, engaging in a transaction online may require time spent for shopping (e.g., item selection) and checkout time (e.g., payment). In such cases, the actual time spent by a user (as monitored by server system 115 or reported to server system 115 by user computing device 105, for example) may be subtracted from an estimated total amount of time saved. In other instances, server system 115 may estimate an amount of shopping time or checkout time for a transaction that is completed at least in part via an electronic network.

Yet another aspect of operation 320 includes estimating travel times (e.g., to and from a store), in one example embodiment. In this aspect, server system 115 may determine an estimated travel time by providing information to a system hosting travel database 130, for example. Thus, using a starting location corresponding to the user (e.g., the user's home or office), server 115 may calculate an estimated amount of time it would take the user to get or from to a store via car, bicycle, bus, subway, or other transportation means.

In some instances, the estimated travel times to and from a store may differ, e.g., based on changing traffic conditions. Travel may also not be a “round trip” in some cases, but a trip from a first location (e.g., work or school) to a store location, and then from the store location to a different location (e.g., home). In such cases, estimated travel times may be adjusted accordingly. For example, if a user is going to commute home in the evening regardless of whether the user makes a shopping trip to a store, the total estimated travel time for a transaction may correspond only to the portions of the user's journey that are not on the most direct route between the two different starting and ending locations. A user therefore may have one or more physical locations associated with him or her, such as home, work, school, etc., which are used to estimate travel times. In some embodiments, a user may specify addresses for such locations and submit this information to server system 115; this information may also be stored in locations database 120 (e.g., by server system 115 or directly by a user).

In some example embodiments, server system 115 may determine a second physical location associated with an alternative transaction (e.g., a merchant location) by comparing one or more estimated travel times from a first physical location associated with a user. Accordingly, server system 115 may determine a plurality of candidate locations (e.g., corresponding to a plurality of merchants) and determine which of these locations would have the shortest estimated travel time. This may allow a better estimate of time savings for a user, as a user may be less likely to travel to a more distant physical location to complete an in-person transaction.

One example embodiment of operation 320 therefore includes the following calculations:

Estimated total time savings=estimated shopping time savings+estimated checkout time savings+estimated travel time savings.

Additional variations of operation 320 are also contemplated, as described herein.

In some cases, whether a transaction is an expedited transaction to be completed by a particular time may affect the calculations of estimated time savings in operation 320. For example, a user who is ordering goods or services may have a choice as to what time or date an order will be delivered. In some instances, a user may use a service such as EBAY NOW which allows delivery in a relatively short amount of time (e.g., within one hour). Such an expedited delivery time may provide a user a high degree of convenience. A user may be preparing dinner, for example, but lack one or more key ingredients. Instead of spending time driving to the store, the user may be able to have items delivered in an expedited manner.

Accordingly, server system 115 may therefore be configured, in some example embodiments, to use a time value premium to calculate an estimated time savings for an expedited transaction. In the example above, a user selecting one hour delivery through a service such as EBAY NOW might save 30 minutes by conducting a transaction online instead of driving to the store. However, server system 115 may add an additional 30 minute time value premium (or other value) to the estimated time saved by the user for the transaction in order to reflect the importance of an expedited order. Leaving to go to the store in this example could delay dinner for a family by 30 minutes or more, and the user may find the time savings provided by a service such as EBAY NOW to be especially valuable. The estimated time saved in operation 320 may therefore include a premium value in some cases.

In some example embodiments, server system 115 may estimate a time savings for a user based on an approximated physical address. An Internet Protocol (IP) address or other network address may be used to approximate a location for a user, which may then be used to estimate a time savings. For example, if an IP address indicates a user lives in a particular town, a geographic point in that town may be used as a first physical location associated with a user for purposes of determining time savings. Thus, in various example embodiments, determining a physical location associated with a user may be performed based on a network address or other information (such as zip code).

In another example embodiment, server system 115 may estimate a time savings for a good or service that the user has not yet selected for purchase. For example, a web page provided by server system 115 that displays goods or services for purchase may include an indication of how much estimated time a user may save by making a purchase of a particular item online (e.g., “save 22 minutes of time by purchasing this chainsaw now”). In some instances, server system 115 may provide such estimations even for an unknown user (e.g., a user who is not logged into an account). In such cases, an approximated location may be used to determine an estimated time savings. Providing such an estimated time savings even prior to purchase may entice a user to make the purchase via a web site, rather than traveling to a store, for example.

Time savings may also be calculated relative to a transaction for a service establishment that provides food or beverages (e.g., a restaurant, bar, coffee shop, etc.). In such transactions, a user may make an advance order via an electronic network, and pick up the item at the establishment. A user may also pre-pay for an order in some instances. For example, a user might pre-order and pre-pay for a coffee to-go on her commute to work. The user may therefore avoid having to wait in line during a busy time and pay with a physical instrument (e.g., cash or credit card). A user may also use a smart phone device to check out of a restaurant, for example, without having to wait for a server to conduct payment using a physical instrument (e.g., cash or credit card at a point-of-sale terminal). Estimated time savings may include an estimated time saved for such a payment (e.g., determining that a user saved five minutes by paying a tab via an electronic network using a smart phone).

In some instances, time of day for a transaction may also affect time savings for a user. Consider the above example of a coffee shop. At a busy time such as 8:00 am, an average wait time to order and receive a coffee might be 20 minutes. At less busy time, such as 3:00 pm, the average wait time might only be 3 minutes. Server system 115 (or database 125) may therefore maintain information regarding estimated or actual wait times for service establishment transactions, as well as other transactions (e.g., a grocery store checkout line at 5:30 pm may be slower than at 10:30 am).

In operation 325, in the example embodiment shown, server system 115 (or other suitable system) causes a balance of an account corresponding to a user to be adjusted based on the time value calculated in operation 320 (e.g., indicating an estimated amount of time saved by the user for at least a portion of a first transaction relative to an alternative transaction). In some example embodiments, the account that is adjusted is a loyalty account having a loyalty points balance. The term loyalty points, as used herein, refers to any quantifiable value that qualifies a user for one or more benefits or is redeemable for one or more benefits. In various example embodiments, loyalty points may be stored as a time balance value (e.g., four hours saved), a monetary value, a value simply expressed in loyalty points with no other corresponding unit of measurement (e.g., three hundred loyalty points), or other suitable value(s) as may be used in various loyalty programs. In one example embodiment, a user may therefore redeem loyalty points for one or more benefits—for example, five hours of cumulative “time saved” for one or more transactions might be redeemed for free shipping on a next transaction.

Thus, operation 325 may involve crediting an account to reflect time saved by a user via a first transaction relative to an alternative transaction. Note that the account that is credited may, in various example embodiments, be the user's own account or another designated account (e.g., spouse's account, or parent's account if the user is a minor). Thus, in some instances, a user may specify to server system 115 an account to be adjusted for a transaction that results in time savings. Loyalty points credited to a user's account may give a user certain discounts, be redeemed for goods or services, or provide other benefits to a user, such as free or discounted shipping. The use of loyalty points earned by time savings for a transaction, however, is not limited to such examples.

In another example embodiment, time savings may be estimated for a first transaction involving a return of one or more goods or services. A user who is returning an item, for example, might pre-authorize the return on line, and then either mail or return the item to a physical store location. In cases where a user returns the item at a store location, the user may simply be able to drop off the item and leave, rather than waiting in line to make the return. Shopping time may therefore be saved in such an example, and estimated as described above relative to various example embodiments.

In an alternate example embodiments of method 300, operation 320 may include calculating a time value indicating an estimated amount of time saved by a retailer (or a party other than a purchaser) in at least a portion of a transaction. In some instances, a retailer for other party) may have merchandise that it wishes to sell rapidly—for example, a bookseller may have an excess of books that would otherwise have to be returned to a wholesaler or destroyed. In such a case, the bookseller would have to spend employee time (and payroll costs) preparing those books to be shipped out of the store. The bookseller may instead choose to run a promotion via a web site in which the excess books are offered fir a significant discount (e.g., 50% off) to any purchaser who is willing to travel to the bookseller's store and pick up the item, in this scenario, time saved by the user may be minimal, but time saved by the bookseller may be substantial (e.g., several hours of employee time, depending on the number of items). A user who purchases such a book may therefore receive loyalty points based on the estimated time savings to the seller. Time savings for the seller may be estimated based on techniques described above—for example, assigning a time savings per item sold (e.g., 2 minutes).

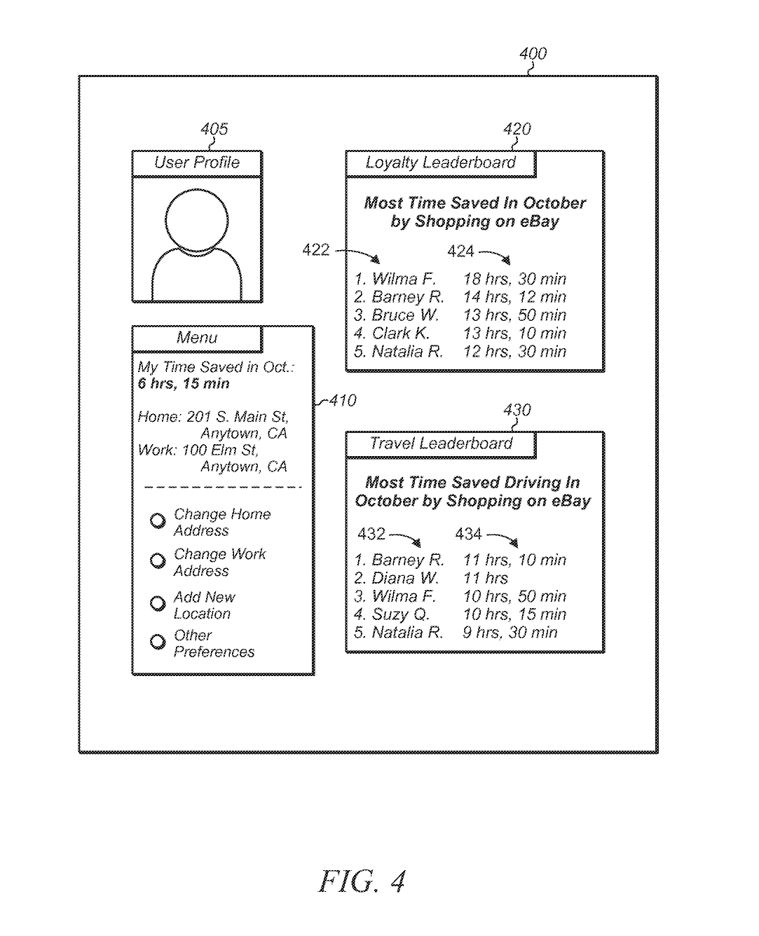

Turning to FIG. 4, a diagram is shown of an example embodiment of a user web page 400 with loyalty-related information for time savings. In this example embodiment, server system 115 may transmit page 400 to a user after that user logs in to a web site such as EBAY.com. The user may also access page 400 by way of a preferences menu or user account menu in some instances.

Page 400 includes a user profile 405 which may include an avatar or picture of a user. In the example embodiment shown, menu 410 displays how much time the user has saved by shopping online during a current month (e.g., October). In other example embodiments, page 400 may include (or make accessible) information about how much time a user has saved in other time periods (e.g., this week, last 12 months, calendar year to date). Menu 410 may also allow a user to change one or more locations associated with the user (such as a home or work address). Menu 410 may also allow other user preferences to be changed in various example embodiments, as consistent with this disclosure.

Page 400 may also include a loyalty leaderboard 420 that displays top users who have saved the most time (e.g., shopping on a web site such as EBAY.com) in a given time period. This leaderboard includes a list of users 422 and a corresponding list 424 of estimated amounts of time saved by those users. In one example embodiment, loyalty leaderboard 420 relates to online transactions conducted at least in part through a single web site, while in other example embodiments, loyalty leaderboard 420 may relate to a plurality of different web sites.

In the example embodiment shown, page 400 also includes a travel leaderboard 430 that displays top users who have saved the most travel time in a given time period. Lists 432 and 434 respectively show users and corresponding estimated amounts of time saved. In some example embodiments, travel leaderboard 430 may show only time saved driving, while in other example embodiments, travel leaderboard may reflect time saved for other modes of transport (e.g., all travel time for all modes of transport, time saved biking, or time saved walking). In another example embodiment, a leaderboard may show savings in terms of distance traveled (e.g., total number of miles saved by transacting online in a given time period). Other types of leaderboards are also contemplated, such as leader-boards that display users who have saved the most time shopping, the most time checking out, or any other quantity of estimated time savings that may be tracked by server system 115 (or other suitable system).

Server system 115 may therefore track estimated amounts of time saved for a plurality of users during one or more particular time periods for one or more transactions, in various example embodiments. Server system 115 may also cause a display of estimated amounts of time saved for one or more users (e.g., displaying this information for a user who is logged in). In one example embodiment, a user may have a running total of time saved for a particular time period displayed after logging in to a site. For example, a banner display on top of a web site such as EBAY.com may show a user how much time she has saved this month ordering online via EBAY, as a positive reminder of the benefits of using that site.

In one example embodiment, server system 115 is configured to provide graphic visualizations or textual explanations to user computing devices regarding the estimated amounts of time saved by users. Such visualizations or explanations may help users better appreciate the time savings provided by participating in online transactions via a web site such as EBAY.com. In one example, a graphic visualization may show children playing soccer, and be accompanied by text stating that “Jim W. saved enough time this month shopping via EBAY to coach his daughter's soccer team.” In another example, a graphical visualization may show a mountain range and be accompanied by text stating that “Terry H. saved enough time this year shopping via EBAY to take a hiking trip on the Appalachian Trail!” In some example embodiments, users may be encouraged to submit their own stories of what they did with the time they saved shopping online. Thus, a web site may display such visualizations and explanations, as well as allowing users to submit their own suggestions (e.g., as part of a contest). In some instances, users may also receive additional loyalty points for making such submissions.

In another example embodiment, server system 115 may also cause displays of information concerning total estimated amounts of time saved by a plurality of different users. For example, server system 115 may display on a web page a banner that states “Users have saved 8 million hours this year by shopping with EBAY.” In other example embodiments, server system 115 may display on a web page a banner that states “EBAY users saved 16 hours on average last month by shopping online with us!”, or “People in California saved 18 hours on average last month by shopping with EBAY” Thus, server system 115 may calculate such quantities based on compiled user statistics.

In some example embodiments, users may use a social network or other means to share information regarding their estimated amounts of time saved fir one or more transactions. Thus, in one example embodiment, page 400 includes a button that allows a user to publish (e.g., via a social networking site such as FACEBOOK.com) how much estimated time they have saved for a single transaction, or their estimated time savings for a given period (e.g., a month). Users may also give server system 115 permission to post such information to their social networking accounts automatically (for example, in response to payment for a purchase via an electronic network, or periodically such as once a week, once a month, etc.).

Turning to FIG. 5, a block diagram illustrating one example embodiment of a non-transitory computer-readable medium 500 is shown. Computer-readable medium 500 includes a transaction module 505, a time savings estimation module 510, and an account balance module 515. These modules may each include computer-executable instructions that may cause a suitable system (e.g., server system 115) to perform particular operations. In various example embodiments, one or more modules of computer-readable medium 500 are configured to perform any and all operations described above relative to method 300 or web page 400.

In the example embodiment shown, transaction module 505 is configured to complete at least a portion of a first transaction via an electronic network. For example, transaction module 505 may allow a user to select one or more goods or services and may accept payment for an order (e.g., via a web page). Transaction module 505 may also determine an alternate transaction to a first transaction, in one example embodiment. Accordingly, transaction module 505 may perform operations such as determining a merchant, same or substitute good or service, and physical location for an alternative transaction.

Time savings estimation module 510 is configured to calculate a time savings for a user in the example embodiment shown. Thus, time savings estimation module 510 may calculate a time savings for travel time, shopping time, or checkout time. Time savings estimation module 510 may therefore perform calculations based on a location associated with a user relative to a different location associated with an alternative transaction, a time of day for a transaction or alternative transaction, etc.

Account balance module 515 is configured to cause a balance of an account corresponding to a user to be adjusted, in the example embodiment shown, based on an estimated amount of time saved by a user in a first transaction. Accordingly, account balance module 515 may transmit information to another system that causes an account balance to be adjusted (for example, credited) to reflect a time savings in a transaction. In some instances, account balance module may directly adjust an account balance by modifying data on server system 115 (e.g., in example embodiments in which server system 115 directly maintains user account balances). As noted above, an account that is adjusted may be credited in various ways, in some example embodiments. Additional modules may also be stored on computer-readable medium 500 in some cases, and may correspond to any functionality or features described herein.

In accordance with techniques disclosed herein, in one example embodiment, computer readable medium 500 may store instructions that allow execution of a method comprising: accessing transaction data indicating an online transaction between an online merchant and a customer with respect to one or more goods or services; in an automated operation using one or more computer processors, estimating a time-saving value representing customer time saved by transacting for the one or more goods or services via the online transaction instead of transacting for the one or more goods or services through an alternative non-online transaction; calculating a customer credit based at least in part on the estimated time-saving value; and causing application of the calculated customer credit a customer account for the customer. In this example embodiment, estimating of the time-saving value may comprise estimating customer time for participating in the online transaction; estimating putative customer time for participating in the alternative non-online transaction; and calculating the time-saving value based on a difference between the estimated customer time for the online transaction and the estimated customer time for the non-online transaction.

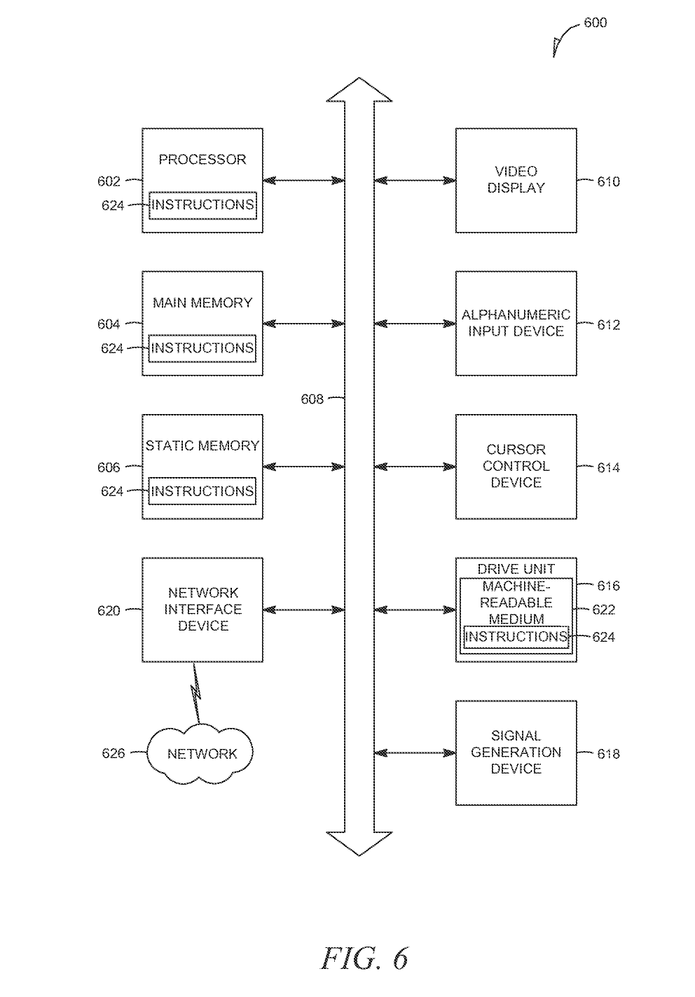

Turning to FIG. 6, a block diagram illustrating components of a machine 900 is shown. Machine 900 may be used to implement client device 105, server system 115, or other computing systems consistent with some example embodiments. Note also that while various operations are described herein relative to server system 115 or client device 105, any suitable system may be used for such operations in various example embodiments.

Machine 600, according to some example embodiments, is able to read instructions 624 from a machine-readable medium 622 (e.g., a computer-readable storage medium) and perform any one or more of the methodologies discussed herein, in whole or in part. Specifically, FIG. 6 shows machine 600 in the example form of a computer system within which instructions 624 (e.g., software, a program, an application, an applet, an app, other executable code) for causing machine 600 to perform any one or more of the methodologies discussed herein may be executed, in whole or in part. In alternative example embodiments, machine 600 operates as a standalone device or may be connected (e.g., networked) to other machines. In a networked deployment, machine 600 may operate in the capacity of a server machine or a client machine in a server-client network environment, or as a peer machine in a distributed (e.g., peer-to-peer) network environment. Machine 600 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 624, sequentially or otherwise, that specify actions to be taken by that machine. Further, while only a single machine is illustrated, the term “machine” shall also be taken to include any collection of machines that individually or jointly execute the instructions 624 to perform all or part of any one or more of the methodologies discussed herein.

Machine 600 includes a processor 602 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 604, and a static memory 606, which are configured to communicate with each other via a bus 608. Processor 602 may contain microcircuits that are configurable, temporarily or permanently, by some or all of instructions 624 such that the processor 602 is configurable to perform any one or more of the methodologies described herein, in whole or in part. For example, a set of one or more microcircuits of processor 602 may be configurable to execute one or more modules (e.g., software modules) described herein.

Machine 600 may further include a graphics display 610 (e.g., a plasma display panel (PDP), a light emitting diode (LED) display, a liquid crystal display (LCD), a projector, a cathode ray tube (CRT), or any other display capable of displaying graphics or video). Machine 600 may also include an alphanumeric input device 612 (e.g., a keyboard or keypad), a cursor control device 614 (e.g., a mouse, a touchpad, a trackball, a joystick, a motion sensor, an eye tracking device, or other pointing instrument), a storage unit 616, an audio generation device 618 (e.g., a sound card, an amplifier, a speaker, a headphone jack, or any suitable combination thereof), and a network interface device 620.

Storage unit 616 includes machine-readable medium 622 (e.g., a tangible and non-transitory machine-readable storage medium, such as computer-readable medium 800) on which are stored the instructions 624 embodying any one or more of the methodologies or functions described herein. Instructions 624 may also reside, completely or at least partially, within the main memory 604, within processor 602 (e.g., within the processor's cache memory), or both, before or during execution thereof by machine 600. Accordingly, main memory 604 and processor 602 may be considered machine-readable media (e.g., tangible and non-transitory machine-readable media). Instructions 624 may be transmitted or received over the network 160 via the network interface device 620 For example, network interface device 620 may communicate the instructions 624 using any one or more transfer protocols (e.g., hypertext transfer protocol (HTTP)).

In some example embodiments, machine 600 may be a portable computing device, such as a smart phone or tablet computer, and have one or more additional input components 630 (e.g., sensors or gauges). Examples of such input components 630 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While machine-readable medium 622 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 624 for execution by machine 600, such that the instructions 624, when executed by one or more processors of machine 600 (e.g., processor 602), cause machine 600 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain example embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some example embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering example embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In example embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method, comprising:
in response to a participant completing at least a portion of a first transaction via an electronic network, a computer system calculating a time value indicating an estimated amount of time saved by the participant in the first transaction, the estimated amount of time being relative to a second estimated amount of time for completing at least a portion of an alternative transaction, the alternative transaction corresponding to a first good or service included in the first transaction; and
based on the time value indicating the estimated amount of time saved, the computer system causing a balance of an account corresponding to the participant to be adjusted.

2. The method of claim 1, wherein the account corresponding to the participant is a loyalty account, and the balance of the account includes loyalty points earned by the participant for one or more transactions.

3. The method of claim 1, further comprising calculating the time value based on an estimated travel time between a first physical location associated with the participant and a second physical location associated with the alternative transaction.

4. The method of claim 3, further comprising accessing a merchants database that includes information specifying a plurality of merchants to determine one or more merchants from which the alternative transaction could be completed.

5. The method of claim 3, further comprising:
accessing a locations database that includes information specifying a plurality of physical locations to determine one or more locations at which the alternative transaction could be completed; and
determining the second physical location by comparing one or more estimated travel times from the first physical location associated with the participant to the one or more locations at which the alternative transaction could be completed.

6. The method of claim 1, further comprising calculating the time value based on an estimated shopping time for the participant to acquire the first good or service via the alternative transaction.

7. The method of claim 1, further comprising calculating the time value based on an estimated checkout time for the participant to acquire a plurality of goods or services, including the same good or service, via the alternative transaction.

8. The method of claim 1, wherein the first transaction is for a return of the firs good or service; and
wherein calculating the time value includes calculating an estimated amount of time saved by the participant in returning the first good or service.

9. The method of claim 1, wherein calculating the time value includes subtracting an amount of time used by the participant to complete at least a portion of the first transaction via the electronic network.

10. The method of claim 1, wherein the first transaction is an expedited transaction to be completed by a particular time; and
wherein calculating the time value includes calculating a time value premium in addition the estimated amount of time saved by the participant.

11. The method of claim 1, wherein the first transaction is for a service establishment that provides food or beverages, and the at least a portion of the transaction corresponds to an advance order via the electronic network or an expedited checkout via the electronic network;
wherein the alternative transaction is for the service establishment and includes a payment made at the service establishment with a physical instrument;
wherein calculating the time value is based on an estimated time value for payment with the physical instrument.

12. An article of manufacture comprising a non-transitory computer-readable medium having stored thereon instructions that, when executed by one or more processors of a computer system, cause the computer system to perform operations comprising:
receiving, via an electronic network to which the computer system is coupled, an indication that a user has completed at least a portion of a first transaction;
determining an alternative transaction to the first transaction, the alternative transaction corresponding to a first good or service included in the first transaction;
calculating a time value indicating an estimated amount of time saved by the user in completing at least the portion of the first transaction, the estimated amount of time being relative to a second estimated amount of time for completing at least a portion of the alternative transaction; and
based on the time value indicating the estimated amount of time saved by the user, causing a balance of an account corresponding to the user to be adjusted.

13. The article of manufacture of claim 12, wherein the operations further comprise:
determining a first physical location associated with the user;
acquiring, from one or more other computer systems via the electronic network, location information indicating one or more second physical locations at which the alternative transaction could be completed; and
calculating the time value based on an estimated travel time between the first physical location associated with the user and a nearest one of the one or more second physical locations.

14. The article of manufacture of claim 12, further comprising:
acquiring, via the electronic network, travel condition information indicative of one or more travel conditions on a route between the first physical location and the nearest second physical location;
wherein calculating the time value is based on the travel condition information.

15. The article of manufacture of claim 12, wherein the operations further comprise:
receiving, via the electronic network, a login notification indicating that user has logged in to an account on a web site associated with the account corresponding to the user; and
subsequent to the login notification, causing a display on a user computing device of a cumulative estimated amount of time saved by the user, the cumulative estimated amount of time corresponding to one or more transactions engaged in by the user on the web site in a particular time period.

16. The article of manufacture of claim 12, wherein the operations further comprise:
tracking a plurality of cumulative estimated amounts of time saved by a corresponding plurality of users corresponding to transactions engaged in by the plurality of users on a web site in a particular time period; and
causing a display on the web site of a leaderboard of a plurality of top users, the plurality of top users including particular ones of the plurality of users that have the largest cumulative estimated amounts of time saved in the particular time period.

17. The article of manufacture of claim 16, wherein the operations further comprise:
tracking a plurality of different categories of estimated amounts of time saved by the plurality of users in the particular time period; and
wherein the leaderboard displays, for each of the plurality of different categories of estimated amounts of time saved, a respective top user having the largest cumulative estimated amount of time saved for that category.

18. A system, comprising:
one or more processors; and
a non-transitory computer-readable medium having stored thereon instructions that, when executed by the one or more processors, cause the system to perform operations comprising:
receiving information indicating a user has completed at least a portion of a first transaction via an electronic network;
determining a first physical location corresponding to the user;
determining a second physical location corresponding to an alternative transaction, the alternative transaction corresponding to a first good or service included in the first transaction;
calculating a time value indicating an estimated amount of time saved by the user in the first transaction, the estimated amount of time being based on an estimated travel time between the first physical location and the second physical location; and
based on the time value indicating the estimated amount of time saved, causing a balance of an account corresponding to the participant to be adjusted.

19. The system of claim 18, wherein causing the balance of the account to be adjusted comprises incrementing a total saved time value for the user by the time value, wherein the total saved time value corresponds to a total estimated amount of time saved by the user for a plurality of transactions.

20. The system of claim 18, wherein the operations further comprise causing at least a portion of the balance to be redeemed for one or more benefits.
